(19) United States
(12) Patent Application Publication
(10) Pub. No.: US 2002/0001388 A1
(43) Pub. Date: Jan. 3, 2002

(54) High speed copy protection method

(76) Inventors: Jung-Wan Ko, Yongin-city (KR); Byung-Jun Kim, Suwon-city (KR)

Correspondence Address: STAAS & HALSEY LLP, 700 11TH STREET, NW, SUITE 500, WASHINGTON, DC, 20001, US

(21) Appl. No.: 09/833,793

(22) Filed: Apr. 13, 2001

(30) Foreign Application Priority Data
Jun. 7, 2000 (KR) 00-31028

(51) Int. Cl. H04L 9/00

(52) U.S. Cl. 380/282; 713/193

(57) ABSTRACT

A high speed copy protection method including encrypting a first region of a text containing a second encryption key data using a first encryption key, and encrypting a second region of the text using a second encryption key based upon the second encryption key data, and transmitting a cipher text. A large amount of cipher text data requiring high speed processing are processed using the second encryption key, which is a key used in a common key encryption method, and a smaller part of the cipher text data are processed using a larger first encryption key as used in a common key or a public key encryption method, thereby satisfying speed and security.

### CROSS-REFERENCE TO RELATED APPLICATIONS

This application claims the benefit of Korean Application No. 2000-31028, filed Jun. 7, 2000, in the Korean Industrial Property Office, the disclosure of which is incorporated herein by reference.

### BACKGROUND OF THE INVENTION

### Field of the Invention

The present invention relates to a method of encrypting digital data, and more particularly, to a high speed copy protection method using a dual encryption key.

### Description of the Related Art

Due to the speed of the Internet, electronic commerce, and the use of digital storage media (DSM), the number of applications in which encryption methods are being used is continually increasing. Examples of areas in which encryption methods are used include security, authentication, and copy protection. Two widely used encryption methods include a common key encryption method and a public key encryption method. The common key encryption method is a method of encrypting digital data using a 40-bit or 56-bit key, and the public key encryption method is a method of encrypting digital data using a 512-bit or 1024-bit key. Although increasing the size of the key used in encryption increases security, it also increases the amount of calculation required for encryption so as to dramatically decrease the processing speed of encryption.

Referring to FIG. 1, which is a block diagram of a conventional encryption apparatus, the encryption apparatus includes a sender 100 to encrypt a text 1 and providing a cipher text 5, and a receiver 200 to receive a key 7 used in encrypting and decrypting the cipher text 5 and restoring the text 1. Besides the sender 100 and the receiver 200, an improved apparatus further includes (not shown) a third party for publicizing, updating, and/or distributing keys.

The sender 100 includes an encryptor 110 to encrypt the text 1 using an encryption key 7 and an authenticator 120 to obtain a safe transmission path 10 through which to transmit the encryption key 7. The receiver 200 includes an authenticator 210 to obtain the safe transmission path 10 through which to receive the encryption key 7 used in encrypting and a decryptor 220 to decrypt the cipher text 5 using the transmitted encryption key 7.

Referring to FIG. 2, which illustrates a flow chart of a conventional copy protection method, the sender 100 (or receiver 200) checks with the corresponding receiver 200 (or sender 100) whether it is okay to send (or receive). When the sender 100 checks with the receiver 200 whether it is okay to send (operation S1), it is checked whether the receiver 200 is ready by the receiver's 200 response (operation S2). Similarly, when the receiver 200 checks with the sender 100 whether it is okay to receive (operation S3), it is checked whether the sender 100 is ready by the sender's 100 response (operation S4).

When the receiver 200 is ready to receive (operation S2) or the sender 100 is ready to send (operation S4), the sender 100 authenticates the receiver 200 (operation S5). In the operation S5, the sender 100 transmits a challenge for authentication to the receiver 200. When the receiver transmits a response to the challenge for authentication to the sender 100, the sender 100 compares the transmitted response and determines whether the response is authentic (operation S6). In the operation S6, when the response is authentic, the receiver 200 authenticates the sender 100 (operation S7). However, in the operation S6, when the response is not authentic, the authentication stops (operation S8).

Similarly, when the receiver 200 transmits a challenge for authentication to the sender 100 and the sender 100 transmits a response to the challenge for authentication to the receiver 200 in the operation S7, the receiver 200 compares the transmitted response and determines whether the response is authentic (operation S9). In the operation S9, when the response is authentic, an authentication key (not shown) is generated and the safe transmission path 10 is obtained (operation S10). In the operation S9, when the response is not authentic, the authentication stops (operation S11). The operations S1 through S11 generally comprise authentication operations.

When the safe transmission path 10 is obtained in the operation S10, a text 1 is encrypted by an encryption key 7, and a cipher text 5 is transmitted (operation 12). The encryption key 7 used in encrypting the text 1 is also encrypted by the authentication key (not shown) generated in the operation S10 and transmitted through the safe transmission path 10 (operation S13). The cipher text 5, which is transmitted through a normal, unsafe transmission path, is decrypted by the encryption key 7 transmitted through the safe transmission path 10, and the text 1 is restored (operation S14).

The method of encrypting the cipher text 5 illustrated in FIG. 2, is the common key encryption method, and an identical encryption key 7 is used in encrypting and decrypting. The transmission path includes a safe transmission path 10 to transmit an encryption key 7, and a normal path used for transmitting encrypted data. On the assumption that decryption cannot be performed without using the encryption key 7, the cipher text 5 is transmitted via the normal path (i.e. an unsafe transmission path), and the normal path is designated as a public path such as an Internet network, or a telephone network, a wireless network, or an area network such as a LAN, WAN, MAN, etc. Further, it is understood that the normal path could include storing the cipher text 5 on a medium and sending the medium by mail.

The most common transmission method for safely transmitting the encryption key 7 used in encrypting is a specific encryption method, and the safe transmission path 10 obtained by authentication is used in the specific encryption method. That is, another encryption method other than that used in encryption of a document is used in the operation S13 of FIG. 2 using the safe transmission path 10 obtained by the authentication. Also, an encryption method, in which a larger authentication key than the encryption key 7 is used, is mainly used. Here, as the size of the authentication key increases, security is increased, but the processing speed is reduced.

Specifically, the sender 100 transmits the encryption key 7 to the receiver 200 via the safe transmission path 10 (operation S13 of FIG. 2). A text 1 to be transmitted is encrypted by the common key encryption method using the encryption key 7 (operation S12 of FIG. 2). Here, since a 40-bit or 56-bit encryption key 7 is mainly used in the common key encryption method, security is decreased, and processing speed is increased. Thus, the common key encryption method is useful for a large amount of data processing. The encrypted cipher text 5 is transmitted to the receiver 200 via an unsafe normal path or a public network or path. The receiver 200 receives the encryption key 7 from the authenticated safe transmission path 10 and decrypts the cipher text 5 and obtains the encryption key 5, and the cipher text 5 processed by the common key encryption method is decrypted using the encryption key 7, and the text 1 is restored.

Since the same encryption key 7 is used in encrypting and decrypting, the method is referred to as a common key (or symmetric key) encryption method. Another method in which a different key is used in encryption and decryption is referred to as a public key (or asymmetric key) encryption method. Usually, in the common key encryption method, the size of the key is small and the encryption method is simple in comparison with the public key encryption method. Thus, the security is relatively low, and its processing speed is relatively high. In the public key encryption method, the size of the key is generally large, processing speed is low, and security is relatively high. Thus, the public key encryption method is used in the operation of authentication for obtaining the safe transmission path 10 (operations S5 through S10 of FIG. 2), and the common key encryption method is used in the operation of data processing for encrypting a text (operations S12 through S14 of FIG. 2).

However, due to the spread of high-performance computers, the security of the encryption methods is being threatened. That is, a personal computer (PC) having improved calculation ability can access the cipher text 5, which is sent through the unsafe public network, without the encryption key 7. Since the size of the encryption key 7 is small and simple, and repetitive tasks are often performed in using the encryption key 7, the encryption key 7 used in the encryption can be found and decryption is possible without using the encryption key 7.

As such, the conventional common key encryption method using the current common encryption key 7 of the size of 40 bits or 56 bits would no longer be used. However, for non-computers, such as information household electric appliances which have a low operation ability, while their security can be increased using the encryption method in which an encryption key 7 having a size greater than 128 bits is used, this increased security is impractical due to the reduced processing speed in these appliances to perform their functions. Further, it is more difficult to introduce the public key encryption method in which an encryption key having a size greater than 512 bits is used. However, while high security like that used in electronic commerce should be available for the information household electric appliances, the current encryption methods can not satisfy both the need for security and the need for speed.

### SUMMARY OF THE INVENTION

To solve the above and other problems, it is an object of the present invention to provide a high speed copy protection method in which a dual key encryption method is implemented.

It is another object of the present invention to provide a high speed copy protection method of encrypting a first region of a text using a first encryption key to increase security, and encrypting a second region of the text using a second encryption key for high speed processing.

Additional objects and advantages of the invention will be set forth in part in the description which follows and, in part, will be obvious from the description, or may be learned by practice of the invention.

Accordingly, to achieve the above and other objects, there is provided a copy protection method to prevent unauthorized copying of digital data during digital data transmission between a sender and a receiver according to an embodiment of the present invention that comprises encrypting a first region of a text containing a second encryption key using a first encryption key, encrypting a second region of the text using the second encryption key to generate a cipher text, and transmitting the cipher text.

According to an aspect of the present invention, the copy protection method further comprises transmitting the first encryption key, region segmentation information for segmenting the text into the first region and the second region, and information related to the second encryption key through a safe transmission path.

According to another aspect of the present invention, the copy protection method further comprises decrypting the first region of the cipher text using the first encryption key and the region segmentation information transmitted through the safe transmission path, extracting the second encryption key from the decrypted first region using the information related to the second encryption key transmitted through the safe transmission path, and decrypting the second region of the cipher text and restoring the text using the extracted second encryption key.

### BRIEF DESCRIPTION OF THE DRAWINGS

The above and other objects and advantages of the present invention will become more apparent and more readily appreciated from the following description of the preferred embodiments, taken in conjunction with the accompanying drawings in which:

FIG. 1 is a block diagram of a conventional encryption system;

FIG. 2 is a flow chart of a conventional copy protection method;

FIG. 3 is a schematic diagram illustrating a high speed copy protection method according to an embodiment of the present invention; and

FIG. 4 is a flow chart of the high speed copy protection method according an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

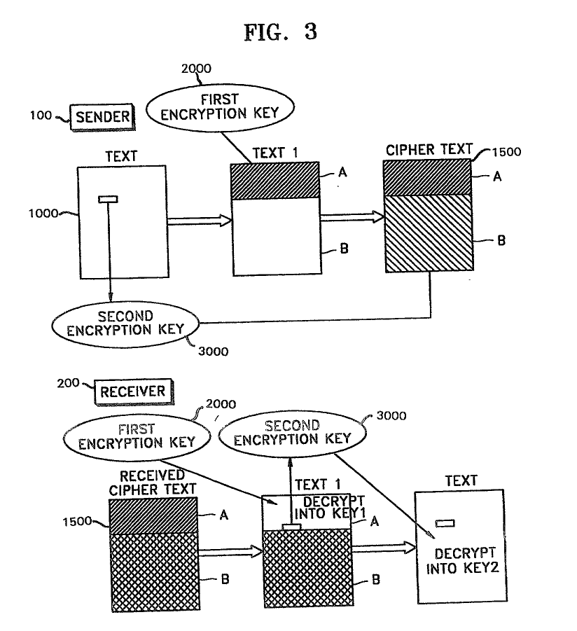

Referring to FIG. 3, a sender 100 extracts data which are at a specific position within a text 1000 to be encrypted, as a second encryption key 3000. The position of the second encryption key data (i.e., the data used to form the second encryption key 3000) can be varied or fixed. The size of the second encryption key 3000 may or may not be the same as that in a conventional common key encryption method. The sender 100 may be a multipurpose or specific purpose computer, a server, of an information appliance.

Meanwhile, where a common key encryption method is used in an embodiment of the present invention, the size of a first encryption key 2000 is larger than that in the conventional common key encryption method. In the case of using a public key encryption method according to another embodiment of the present invention, the size of the first encryption key 2000 may be the same as that in the conventional public key encryption method.

A predetermined region A of the text 1000 is encrypted using the first encryption key 2000. During encryption of the predetermined region A, the predetermined region A (hereinafter referred to as a “first region A”) must include data to be extracted as the second encryption key 3000. The other region of the text 1000 is referred to as a second region B. The size of the first region A and the second region B can be varied, but the size and the segmentation region of respective encryption keys (first and second encryption keys 2000 and 3000) between the sender 100 and a receiver 200 must be the same.

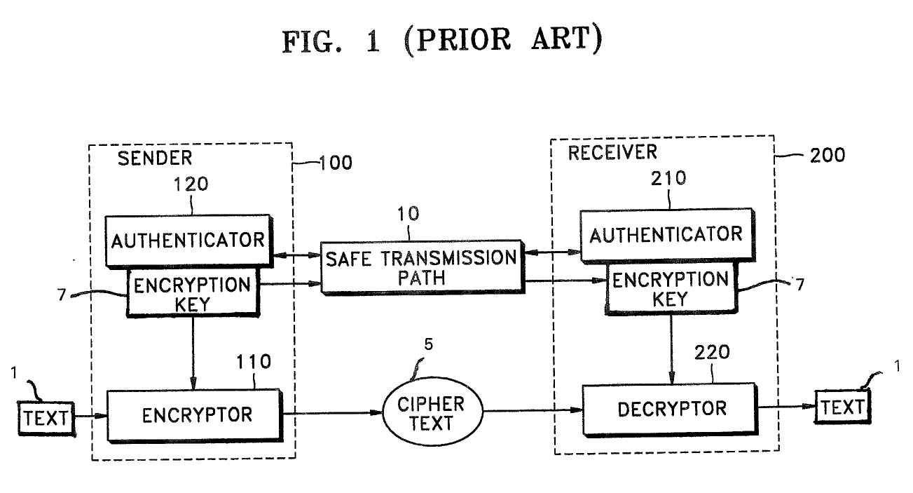

That is, the first region A and the second region B are predetermined, and the first region A is encrypted as the first encryption key 2000 after the second encryption key 3000 is extracted from the first region A. Next, the second region B is encrypted using the second encryption key 3000. Subsequently, a safe transmission path 10 of FIG. 1 is obtained, and the first encryption key 2000 is transmitted to the receiver 200 via the safe transmission path 10 of FIG. 1. A cipher text 1500 can be transmitted through a normal unsecured path.

As described above, the text data 1000 can be therefore encrypted, with the first encryption key 2000 used in the encryption being the same, but where the second encryption key 3000 extracted from the first region A is different.

The receiver 200 decrypts the first region A using the first encryption key 2000 transmitted through the safe transmission path 10 of FIG. 1, extracts the second encryption key 3000 from the decrypted first region A, and decrypts the second region B to then obtain the text 1000. The receiver 200 may be a multipurpose or specific purpose computer, a server, of an information appliance.

The safe transmission path 10 of FIG. 1 is obtained through authentication. Here, information on the segmentation of each region (such as a starting address of the second region B or the size of the first region A), the size of the first and second encryption keys 2000 and 3000 according to the receiver's operation ability, the position of the second encryption key 3000, and information on encryption of each region A and B can be shared.

Thus, more variable and safer encryption can be realized, where the encryption uses a high speed copy protection method according to the present invention that can be applied to a conventional encryption apparatus as shown in FIG. 1. Whereas the conventional encryption apparatus transmits only the encryption key 7 for encrypting the text 1 via the safe transmission path 10, using the encryption method according to the present invention, the first encryption key 2000 is used to encrypt the first region A of the text 1000, the second encryption key information (the size and position of the second encryption key 3000 used to encrypt the second region B), and the region segmentation information are transmitted via the safe transmission path 10. Here, the first region A containing the second encryption key 3000 is smaller than the second region B, and the size of the first encryption key 2000 is larger than that of the second encryption key.

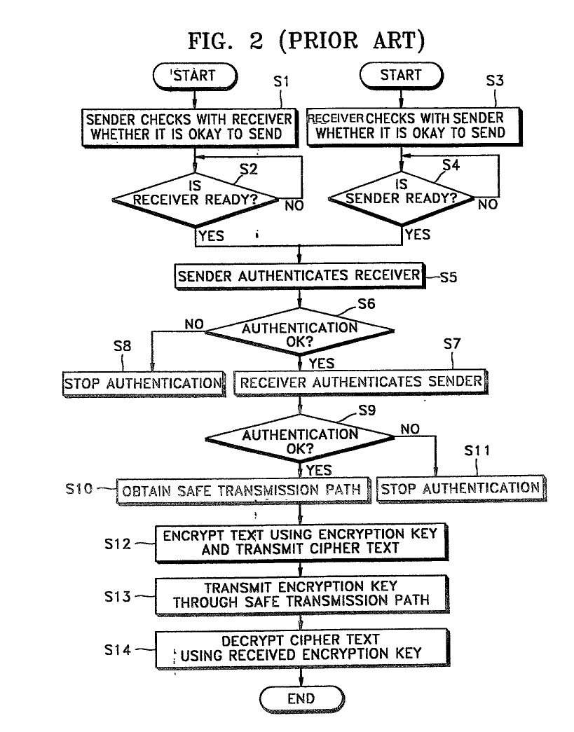

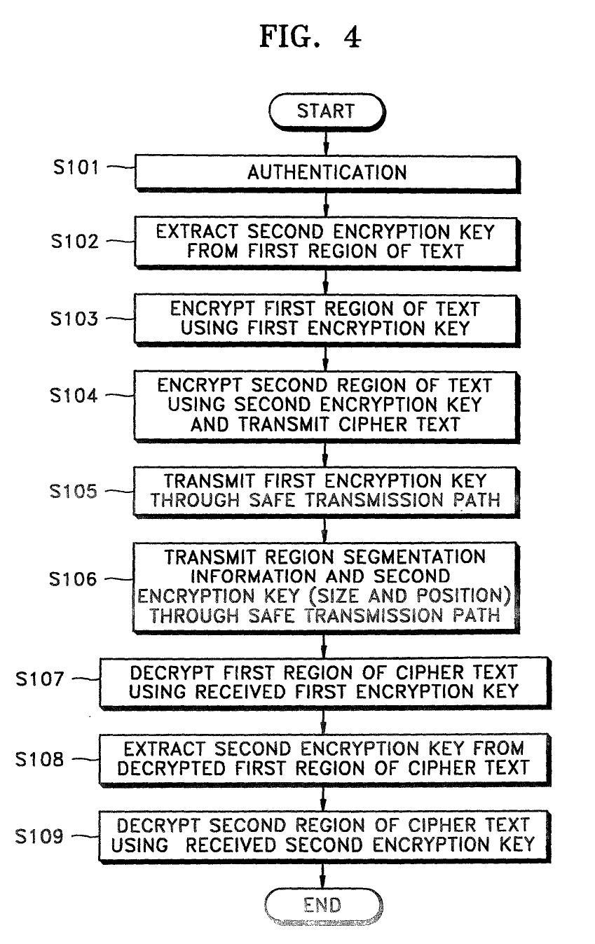

Referring to FIG. 4, the safe transmission path 10 is obtained in operation 101 using a conventional authorization procedure as shown in operations S1 through S11 of FIG. 2. After authentication (operation S101), the second encryption key 3000 is extracted from the first region A of the text 1000 (operation S102). The first region A is encrypted using the first encryption key 2000 (operation S103). The second region B of the text 1000 is encrypted using the second encryption key 3000 and the cipher text 1500 is transmitted (operation S104). The first encryption key 2000 is transmitted through the safe transmission path 10 of FIG. 1 (operation S105), as is the region segmentation information and the second encryption key information (size and position) (operation S106). It is understood that the method shown in FIG. 4 can be performed by a computer program embedded on a computer readable medium.

Meanwhile, the receiver 200 decrypts the first region A of the cipher text 1500 using the received first encryption key 2000 and the region segmentation information (operation S107). The second encryption key 3000 is extracted from the decrypted first region A of the cipher text 1500 using the received second encryption key information (size and position) (operation S108). The second region B of the cipher text 1500 is decrypted using the extracted second encryption key 3000 (operation S109).

Accordingly, the present invention uses the first encryption key, which is larger than that in the conventional common key encryption method or the first encryption key used in the public key encryption method, to encrypt the first region of the text containing the second encryption key, thereby enhancing its security. The second encryption key, which is smaller than the first encryption key used in the common key encryption method, is used in the second region of the text. As a result, a large amount of data requiring high speed processing are processed using the key of the common key encryption method, and part of the cipher text is processed using the large common key or the key of the public key encryption method such that speed and security can be simultaneously satisfied.

While not shown, it is understood that security could be additionally enhanced by using additional keys could be extracted from the text. For instance, a third key could be extracted from the second or first portion of the text in order to encrypt a third portion of the text.

Accordingly, since the present invention uses a first encryption key larger than that in the conventional method and decrypts most of the data using the small second encryption key, its security is increased without requiring an increased operation ability and processing time.

As described above, the present invention increases and improves security and speed using dual encryption keys. The present invention securely transmits only a part of the transmitted key, compared with conventional encryption methods for copy protection, which also increases security. Further, the present invention encrypts part of the text using the second encryption key. Thus, the first encryption key is sufficient for the second encryption key to be transmitted through a safe transmission path, and the second encryption key, which is one of the dual keys, is always varied. As a result, encryption keys which are varied according to each transmission unit are transmitted, which further enhances security.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A copy protection method to prevent unauthorized copying of digital data during digital data transmission between a sender and a receiver, comprising:
encrypting a first region of a text containing a second encryption key using a first encryption key;
encrypting a second region of the text using the second encryption key; and
transmitting a cipher text comprising the encrypted first and second regions.

2. The copy protection method according to claim 1, further comprising:
transmitting the first encryption key, region segmentation information for segmenting the text into the first region and the second region, and information related to the second encryption key through a safe transmission path.

3. The copy protection method according to claim 1, wherein the first encryption key comprises an encryption key for use with a common key encryption method.

4. The copy protection method according to claim 1, wherein the first encryption key comprises a public key for use with a public key encryption method.

5. The copy protection method according to claim 1, wherein the second encryption key is smaller than the first encryption key where a common key encryption method is used.

6. The copy protection method according to claim 1, wherein a size of the first encryption key is fixed, and a size of the second encryption key is varied by a transmission unit within the first region.

7. The copy protection method according to claim 2, wherein the information related to the second encryption key includes size and position information of the second encryption key.

8. The copy protection method according to claim 7, wherein the position and size information of the second encryption key are fixed.

9. The copy protection method according to claim 7, wherein the position and size information of the second encryption key are varied.

10. The copy protection method according to claim 2, wherein the first region of the text is smaller than the second region of the text.

11. The copy protection method according to claim 2, wherein the region segmentation information comprises information on a starting address of the second region of the text.

12. The copy protection method according to claim 2, further comprising:
decrypting the first region of the transmitted cipher text using the transmitted first encryption key and the transmitted region segmentation information;
extracting the second encryption key from the decrypted first region using the transmitted information related to the second encryption key; and
decrypting the second region of the transmitted cipher text using the extracted second encryption key.

13. A copy protection method for decrypting a cipher text received from a sender who encrypts a first region of a text containing a second encryption key information using a first encryption key, encrypts a second region of the text using the second encryption key based upon the second encryption key information, and transmits the cipher text, the first encryption key, region segmentation information, and second encryption key information to a receiver, comprising:
decrypting the first region of the cipher text using the transmitted first encryption key and the transmitted region segmentation information;
extracting the second encryption key from the decrypted first region using the transmitted second encryption key information; and
decrypting the second region of the cipher text using the extracted second encryption key.

14. The copy protection method according to claim 13, wherein a size of the first encryption key is fixed, and a size of the second encryption key is varied according to a transmission unit within the first region.

15. The copy protection method according to claim 13, wherein the first region of the text is smaller than the second region of the text, and a size of the first encryption a key is larger than a size of the second encryption key.

16. The copy protection method according to claim 2, wherein the region segmentation information comprises information on a size of the first region of the text.

17. The copy protection method according to claim 3, wherein the large first encryption key comprises an encryption key that is 56 bits or more.

18. A computer readable medium encoded with processing instructions for implementing a method of encrypting a text sent between a sender and a receiver performed by a computer, the method comprising:
encrypting a first region of the text using a first encryption key, where the first region contains a second encryption key; and encrypting a second region of the text using the second encryption key.

19. The computer readable medium according to claim 18, further comprising sending the first encryption key and information related to the second encryption key through a safe transmission path.

20. The computer readable medium according to claim 19, wherein the first encryption key comprises a symmetric key having 56 bits or more.

21. The computer readable medium according to claim 19, wherein the first encryption key comprises an asymmetric key for use with an asymmetric key encryption method.

22. The computer readable medium according to claim 18, wherein the second encryption key is smaller than the first encryption key.

23. The computer readable medium according to claim 18, wherein a size of the first encryption key is fixed, and a size of the second encryption key is varied by a transmission unit within the first region.

24. The computer readable medium according to claim 19, wherein the information related to the second encryption key includes size and position information of the second encryption key.

25. The computer readable medium according to claim 24, wherein the position and size information of the second encryption key are fixed.

26. The computer readable medium according to claim 24, wherein the position and size information of the second encryption key are varied.

27. The computer readable medium according to claim 19, wherein the first region is smaller than the second region.

28. The computer readable medium according to claim 24, further comprising sending information on a starting address of the second region through the safe transmission path.

29. The computer readable medium according to claim 28, further comprising sending a cipher text comprising the encrypted first and second portions through an unsafe transmission path; and
obtaining the safe transmission path through authentication operations.

30. A computer readable medium encoded with processing instructions for implementing a method of decrypting an encrypted text sent between a sender and a receiver performed by a computer, the method comprising:
decrypting a first region of the encrypted text using a first encryption key, where the first region contains a second encryption key;
decrypting a second region of the encrypted text using the second encryption key.

31. The computer readable medium according to claim 30, wherein said decrypting the first region further comprises:
decrypting the first region using region segmentation information; and
extracting the second encryption key from the decrypted first region using information related to the second encryption key.

32. The computer readable medium according to claim 31, wherein the region segmentation information, the information related to the second key, and the first encryption key are received through a safe transmission path.

33. The computer readable medium according to claim 32, further comprising receiving the encrypted text through an unsafe transmission path.

34. The computer readable medium according to claim 30, wherein a size of the first encryption key is fixed, and a size of the second encryption key is varied according to a transmission unit within the first region.

35. The computer readable medium according to claim 30, wherein the first region of the text is smaller than the second region of the text, and a size of the first encryption key is larger than a size of the second encryption key.

36. A sender for sending encrypted text, comprising:
an authenticator to obtain a safe transmission path through which a first encryption key and information related to a second encryption key are sent; and
an encryptor to encrypt a text using the first encryption key and the second encryption key, where the second encryption key is extracted from a portion of the text encrypted by the first encryption key.

37. The sender of claim 36, wherein
the information related to the second encryption key comprises size and position information of the second encryption key, and
the encrypted text is sent through an unsafe transmission path.

38. The sender of claim 37, wherein the sender comprises an information appliance.

39. The sender of claim 37, wherein the sender comprises a computer.

40. The sender of claim 37, wherein the sender comprises a server.

41. A receiver for receiving encrypted text, comprising:
an authenticator to obtain a safe transmission path through which a first encryption key and information related to a second encryption key are received, and
a decryptor to decrypt a portion of the text using the first encryption key, to extract the second encryption key from the decrypted portion using the information related to the second encryption key, and to decrypt another portion of the text using the second encryption key.

42. The receiver of claim 41, wherein
the information related to the second encryption key comprises size and position information of the second encryption key, and
the encrypted text is received through an unsafe transmission path.

43. The receiver of claim 42, wherein the sender comprises an information appliance.

44. The receiver of claim 42, wherein the sender comprises a computer.

45. The receiver of claim 42, wherein the sender comprises a server.
